(19) United States
(12) Patent Application Publication
(10) Pub. No.: US 2024/0192133 A1
(43) Pub. Date: Jun. 13, 2024

(54) DARK-FIELD INSPECTION DEVICE WITH REAL TIME VARIABLE FUNCTION

(71) Applicant: NEXTIN, Inc., Gyeonggi-do (KR)

(72) Inventors: Tae Hoon Park, Gyeonggi-do (KR); Oh Hyung Kwon, Gyeonggi-do (KR)

(21) Appl. No.: 18/527,829

(22) Filed: Dec. 4, 2023

(30) Foreign Application Priority Data
Dec. 7, 2022 (KR) 10-2022-0169291

(51) Int. Cl. G01N 21/47

(52) U.S. Cl. CPC G01N 21/4738; G01N 2201/0636

(57) ABSTRACT

The present invention relates to a dark-field inspection device, and more particularly, to a dark-field inspection device capable of varying a wavelength of illumination light, selectively receiving a wavelength of scattered light, and adjusting an irradiation area of the illumination light.

### CROSS-REFERENCE TO RELATED APPLICATIONS

This application claims priority under 35 U.S.C. § 119 to Korean Patent Application No. 10-2022-0169291, filed on Dec. 7, 2022, in the Korean Intellectual Property Office, the disclosure of which is incorporated herein by reference in its entirety.

### TECHNICAL FIELD

The following disclosure relates to a dark-field inspection device, and more particularly, to a dark-field inspection device capable of varying a wavelength of illumination light, selectively receiving a wavelength of scattered light, and adjusting an irradiation area of the illumination light.

### BACKGROUND

In general, dark field refers to a field of view obtained in a microscope when illumination light does not enter an objective lens directly, but scattered light generated by hitting an observation object in a state in which a background is dark enters the objective lens. Here, the illumination light is usually projected from a side of the observation object. By using a Tyndall phenomenon, in which dust appears shiny when light enters a dark room, even small particles that may not be seen with an ordinary microscope can be identified.

A dark-field lighting system used in a defect inspection field, such as a semiconductor wafer, using the dark-field principle requires a method of illuminating an observation object while avoiding external interference of an imaging optical system lens (including a macro lens, a microscope objective lens, etc.) that views the observation object. In this case, it is preferable to provide lighting to the observation object with a uniform intensity distribution.

FIG. 1 is a diagram schematically illustrating a dark-field lighting system. A dark-field lighting system 20 includes a light source 23 that diagonally illuminates a sample 21, such as a semiconductor wafer, with light 22, an objective lens 24 on which light scattered from the sample 21 is incident, a tube lens 25 on which light passing through the objective lens 24 is incident, and a camera 26 that collects the light collected from the tube lens 25.

This dark-field lighting system has the following problems.

1. Depending on the physical properties of the sample, there may be differences in a degree to which illumination light is transmitted and a penetration depth.

2. When inspecting the surface of the sample, loss of light quantity may occur due to light transmission, and signals due to internal reflection may be mixed depending on the penetration depth.

3. As the light source is generally composed of a single wavelength, it is difficult to optimize the light source in response to various types of samples.

4. When the irradiation area of the illumination light is large compared to the sample, unintended diffuse reflection signals may be mixed in the remaining areas except the sample.

Therefore, there is a need to solve the above problems.

### RELATED ART DOCUMENT

### Patent Document

(Patent Document 1) Korean Patent Publication No. 10-1304615 (registered on Aug. 30, 2013)

### SUMMARY

An embodiment of the present invention is directed to providing a dark-field inspection device, and provides a dark-field inspection device capable of varying a wavelength of illumination light, selectively receiving a wavelength of scattered light, and adjusting an irradiation area of the illumination light.

In one general aspect, a dark-field inspection device includes: a lighting unit that illuminates a sample with illumination light; and a light receiving unit that collects scattered light scattered from the sample when the illumination light is irradiated to the sample, in which the lighting unit may be configured to vary a wavelength of the illumination light irradiated from the lighting unit.

The lighting unit may include a light source, a variable bandpass filter that passes light of different wavelength bands for each position, and a control unit, the control unit may adjust a position of the variable bandpass filter, and among the light emitted from the light source, only light in a specific wavelength band matching the position of the variable bandpass filter may pass, so the wavelength of the illumination light may be configured to be variable.

The light source may be a multi-wavelength light source or a white light source.

The lighting unit may include a plurality of light sources that emit light of different wavelengths respectively a mixing optical system that passes only light emitted from one of the plurality of light sources or mixes light emitted from two or more light sources and passes the mixed light, and a control unit, the control unit may individually control power supplies of each of the plurality of light sources, and the wavelength of the illumination light may be configured to be variable through interaction between the plurality of light sources and the mixing optical system.

The mixing optical system may include at least one dichroic mirror.

The light receiving unit may be configured to selectively receive light in a specific wavelength band among the scattered light.

The light receiving unit may include a variable bandpass filter that passes light of different wavelength bands for each position, a control unit, and a camera that collects the light passing through the variable bandpass filter, and the control unit may adjust a position of the variable bandpass filter, so, among the scattered light, only light in a specific wavelength band matching the position of the variable bandpass filter may be configured to pass through and be collected by the camera.

The control unit may adjust the position of the variable bandpass filter to match the wavelength of the illumination light irradiated from the lighting unit.

The light receiving unit may include n dichroic mirrors that reflect light of different wavelengths respectively and n reflected light collection cameras that individually match each dichroic mirror to collect the light reflected from each of the n dichroic mirrors, and a passing light collection camera that collects light passing through all the n dichroic mirrors, so, among the scattered light, light in a wavelength band matching the reflection band of each of the dichroic mirrors may be reflected and collected by the reflected light collection camera that matches each dichroic mirror (where n is a natural number of 2 or more).

The light receiving unit may include a mirror plate that includes n dichroic mirrors that reflect light of different wavelengths respectively and is driven to rotate in a turret manner, a control unit, a reflected light collection camera that collects light reflected from the mirror plate, and a passing light collection camera that collects light passing through the mirror plate, and the control unit may rotate the mirror plate, so, among the scattered lights, light in a wavelength band matching the reflection band of any one dichroic mirror of the mirror plate may be reflected and collected by the reflected light collection camera, and light in the remaining band may be configured to pass through and be collected by the passing light collection camera (where n is a natural number of 2 or more).

The lighting unit may include a light source and a lens optical system that is composed of a plurality of lenses for forming the light emitted from the light source in a line shape, so the lighting unit may irradiate line light of a certain length.

The dark-field inspection device may further include a light length adjustment unit that adjusts a length of the line light irradiated from the lighting unit.

The light length adjustment unit may include a shutter that is installed at a position in an optical path between the light source and the sample and configured to be open and closed, and a control unit that controls the opening and closing of the shutter, and the length of the line light may be adjusted according to a degree of opening and closing of the shutter.

The shutter may include a first shutter unit that is opened and closed in a first direction, and a second shutter unit that is opened and closed in a second direction, the control unit may include a first control unit that controls the opening and closing of the first shutter unit, and a second control unit that controls the opening and closing of the second shutter unit, and the first shutter unit and the second shutter unit may be controlled simultaneously or individually by the first control unit and the second control unit.

An imaging surface on which the light emitted from the light source is imaged in a line shape may be formed at a position inside the lens optical system, and the shutter may be installed on the imaging surface.

### BRIEF DESCRIPTION OF THE DRAWINGS

FIG. 1 is a diagram schematically illustrating a dark-field lighting system.

FIG. 2 is a diagram schematically illustrating a dark-field inspection device of the present invention.

FIG. 3 is a schematic diagram of a lighting unit of the present invention.

FIG. 4 is a schematic diagram of a lighting unit according to a first embodiment of the present invention.

FIG. 5 is a diagram schematically illustrating position adjustment of a variable bandpass filter by a control unit.

FIG. 6 is a schematic diagram of a lighting unit according to a second embodiment of the present invention.

FIG. 7 is a schematic diagram of a light receiving unit according to a first embodiment of the present invention.

FIG. 8 is a schematic diagram of a light receiving unit according to a second embodiment of the present invention.

FIG. 9 is a schematic diagram of a light receiving unit according to a third embodiment of the present invention.

FIG. 10 is a diagram schematically illustrating a light length adjustment unit according to an example of the present invention.

FIG. 11 is a diagram schematically illustrating an operation of the light length adjustment unit.

FIG. 12 is a diagram illustrating line light irradiated to each sample position. 10: Dark-field inspection device.

### DETAILED DESCRIPTION OF MAIN ELEMENTS

100, 100A, 100B: Lighting unit
110: Light source module
120: Lens optical system
200, 200A, 200B, 200C: Light receiving unit
300: Light length adjustment unit
L0: Light emitted from light source
L1: Illumination light
L2: Scattered light

### DETAILED DESCRIPTION OF EMBODIMENTS

Hereinafter, the present invention will be described in detail with reference to the accompanying drawings.

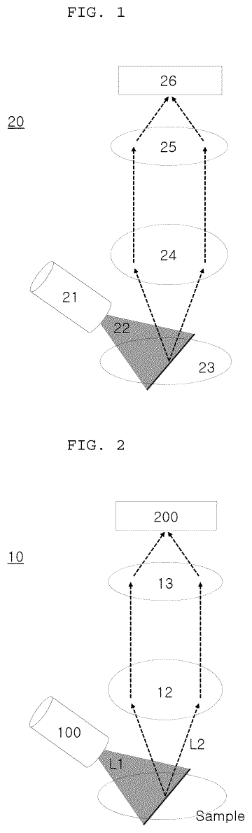

FIG. 2 is a diagram schematically illustrating a dark-field inspection device of the present invention. A dark-field inspection device 10 of the present invention is a device for inspecting a sample, and the device 10 may correspond to surface inspection equipment that inspects a surface of a sample such as a semiconductor wafer, for example.

The device 10 largely includes a lighting unit 100 and a light receiving unit 200, and may be configured to further include optical elements such as an objective lens 12 and a tube lens 13 installed in an optical path between the lighting unit 100 and the light receiving unit 200.

The lighting unit 100 irradiates illumination light L1 to the sample, and the light receiving unit 200 irradiates the illumination light L1 to a sample S and collects scattered light L2 scattered from the sample S. The scattered light L2 scattered from the sample may pass through the objective lens 12, the tube lens 13, etc., and be incident on the light receiving unit 200.

In this case, the lighting unit 100 of the present invention is configured to vary a wavelength (i.e., frequency or color) of the illumination light L1 irradiated from the lighting unit 100. That is, the present invention can vary the wavelength of the illumination light irradiated to the sample in response to physical properties of the sample that vary depending on the sample. Hereinafter, the lighting unit 100 capable of performing the wavelength variable function will be described through specific embodiments.

First, the lighting unit 100 of the present invention may irradiate line light. That is, the illumination light L1 irradiated from the lighting unit 100 may be light in the shape of a line with a certain length, which may be referred to as line light.

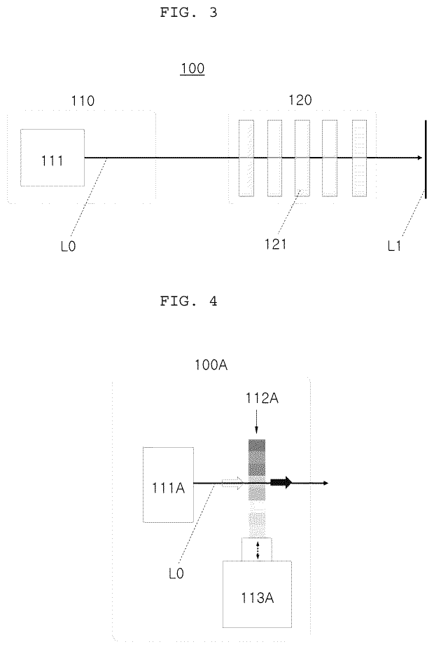

FIG. 3 is a schematic diagram of the lighting unit of the present invention. The lighting unit 100 largely includes a light source module 110 that includes a light source 111, and a lens optical system 120 that is composed of a plurality of lenses 121 for forming light L0 emitted from the light source 111 in the line shape. Accordingly, the lighting unit 100 of the present invention can radiate the line light L1 of a certain length.

When using such line light, a sample inspection time may be greatly shortened, and as will be described later, there is an advantage in that the illumination light may be intensively irradiated only to the sample by adjusting the length of the line light.

FIG. 4 is a schematic diagram of a lighting unit according to a first embodiment of the present invention. This example utilizes a multi-band light source.

As illustrated, a lighting unit 100A of this example includes a light source 111A, a variable bandpass filter 112A, and a control unit 113A. Here, the lighting unit 100A may correspond to the light source module 110 of the lighting unit 100 of FIG. 3 described above, and the light source 111A of the lighting unit 100A may correspond to the light source 111 of the light source module 110 of FIG. 3 described above.

The light source 111A is configured as a multi-band light source, for example, a multi-wavelength light source or a white light source.

The variable bandpass filter 112A is a filter that passes only light in a specific wavelength band, and is configured to pass light in different wavelength bands for each position. As an example, as illustrated in FIG. 4, the variable bandpass filter 112A is formed in a rectangular thin rectangular parallelepiped structure (similar to slide glass), and may have a structure in which different bandpass filters are continuously connected at each position.

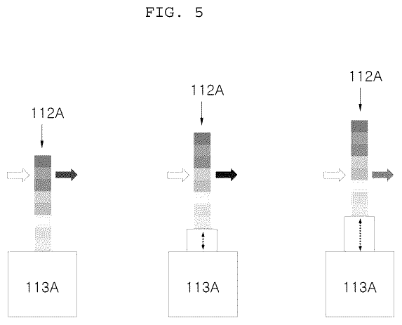

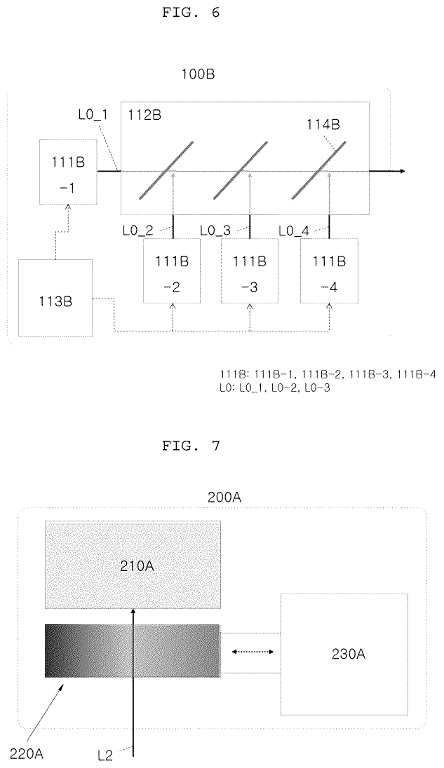

The control unit 113A adjusts the position of the variable bandpass filter 112A. FIG. 5 is a diagram schematically illustrating the position adjustment of the variable bandpass filter by the control unit. As illustrated, the control unit 113A is a kind of actuator that may move the variable bandpass filter 112A forward or backward in one direction, and correspondingly, the wavelength band of light that the variable bandpass filter 112A passes may be changed.

Accordingly, among the light L0 emitted from the light source 111A, only light in a specific wavelength band matching the position of the variable bandpass filter 112A passes, and by this configuration, the wavelength of the illumination light L1 irradiated from the lighting unit 100 may be variable.

FIG. 6 is a schematic diagram of a lighting unit according to a second embodiment of the present invention. This example utilizes a mixture of a plurality of wavelength light sources.

As illustrated, a lighting unit 100B of this example includes a plurality of light sources 111B, a mixing optical system 112B, and a control unit 113B. Here, the lighting unit 100B may correspond to the light source module 110 of the lighting unit 100 of FIG. 3 described above, and the plurality of light sources 111B of the lighting unit 100B may correspond to the light source 111 of the light source module 110 of FIG. 3 described above.

Each of the plurality of light sources 111B emits light L0 of different wavelengths. That is, each light source 111B-1, 111B-2, etc., emits light of different colors. For example, the first light source 111B-1 may emit light L0_1 of a first wavelength, and the second light source 111B-2 may emit light L0_2 of a second wavelength.

The mixing optical system 112B passes only light emitted from one of the plurality of light sources 111B, or passes a mixture of light emitted from two or more light sources. For example, as illustrated in FIG. 6, the mixing optical system 112B includes at least one dichroic mirror 114B, and the first light source 111B-1 is arranged on one side of the dichroic mirror 114B and one of the remaining light sources is arranged on the other side of the dichroic mirror 114B. The dichroic mirror 114B may be configured to individually match each of the remaining light sources except for the first light source 111B-1. The dichroic mirror 114B is an optical element that reflects light in a specific wavelength and passes light in other wavelengths except for the corresponding wavelength. The dichroic mirror 114B matching the second light source 111B-2 reflects the wavelength of the second light source 111B-2 and the dichroic mirror 114B matching the third light source 111B-3 reflects the wavelength of the third light source 111B-3, and this regularity may be generalized to form the mixing optical system 112B.

The control unit 113B individually controls the power supplies of each of the plurality of light sources 111B. That is, the control unit 113B may individually control the power supplies of each of the first to fourth light sources 111B-1 to 114B-4 and turn on or off the power supply of at least one light source.

Accordingly, the wavelength of the illumination light L1 irradiated from the lighting unit 100 may vary due to interaction between the plurality of light sources 111B and the mixing optical system 112B. For example, when wanting to use the light of the wavelength of the first light source 111B-1 as the illumination light, the control unit 113B may turn on only the power supply of the first light source 111B-1 and turn off the power supplies of the remaining light sources, so the illumination light may be formed as the wavelength of the light L0_1 emitted from the first light source. The same principle applies to other light sources other than the first light source 111B-1. At the same time or separately, when wanting to use the light of the wavelength between the first light source 111B-1 and the second light source 111B-2 as the illumination light, the control unit 113A may turn on only the power supplies of the first light source 111B-1 and the second light source 111B-2 and turn off the power supplies of the remaining light sources, so the illumination light may be formed of a wavelength between the wavelength of the light L0_1 emitted from the first light source 111B-1 and the wavelength of the light L0_2 emitted from the second light source 111B-2. The same principle applies to light sources other than the first and second light sources, and three or more or all light sources may be mixed.

In this way, the present invention has the advantage of being able to vary the wavelength of the illumination light irradiated to the sample, thereby minimizing the penetration loss and penetration depth of the illumination light into the sample.

Next, in the present invention, in addition to the configuration of the lighting unit 100 described above, the light receiving unit 200 may be configured to selectively receive light in a specific wavelength band among the scattered light scattered from the sample. That is, in the present invention, as described above, the wavelength of illumination light L1 irradiated from the lighting unit 100 is variable, and the light receiving unit 200 may be configured to receive only light in a band that matches the wavelength of the illumination light L1 in response thereto.

FIG. 7 is a schematic diagram of a light receiving unit according to a first embodiment of the present invention. This example utilizes a variable bandpass filter.

As illustrated, the light receiving unit 200A of this example includes a camera 210A, a variable bandpass filter 220A, and a control unit 230A. Here, the light receiving unit 200A may correspond to the light receiving unit 200 of FIG. 2 described above.

First, the variable bandpass filter 220A is a filter that passes only light in a specific wavelength band, and is configured to pass light in different wavelength bands for each position. As an example, as illustrated in FIG. 7, the variable bandpass filter 220A is formed in a rectangular thin rectangular parallelepiped structure (similar to slide glass), and may have a structure in which different bandpass filters are continuously connected at each position.

The control unit 230A adjusts the position of the variable bandpass filter 220A. The control unit 230A is a type of actuator and may move the variable bandpass filter 220A forward or backward in one direction, and correspondingly, the wavelength band of light that the variable bandpass filter 220A passes may be changed.

Then, the camera 210A collects light that has passed through the variable bandpass filter 220A. The camera 210A may be a line camera capable of collecting line-shaped light, and the camera in other embodiments may also be a line camera.

By configuring the light receiving unit 200A in this way, only light in a specific wavelength band matching the position of the variable bandpass filter 220A among the scattered light L2 scattered from the sample may pass and be collected by the camera 210A.

Furthermore, the control unit 230A may adjust the position of the variable bandpass filter 220A to match the wavelength of the illumination light L1 irradiated from the lighting unit. Through this configuration, the present invention may selectively collect the scattered light L2 matching the wavelength of the illumination light L1.

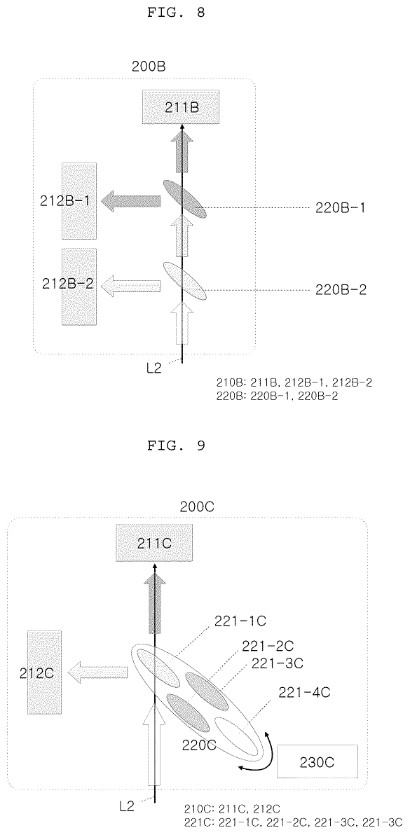

FIG. 8 is a schematic diagram of a light receiving unit according to a second embodiment of the present invention. This example utilizes a plurality of dichroic mirrors.

As illustrated, the light receiving unit 200B of this example includes a camera 210B and a dichroic mirror 220B. Here, the light receiving unit 200B may correspond to the light receiving unit 200 of FIG. 2 described above.

More specifically, the light receiving unit 200B of this example may be configured to include n dichroic mirrors 220B that reflect light of different wavelengths respectively n reflected light collection cameras 212B-1 and 212B-2 that individually match each dichroic mirror 220B-1, 220B-2, etc., to collect the light reflected from each of the n dichroic mirrors 220B, and a passing light collection camera 211B that collects light passing through the n dichroic mirrors 220B. Here, n is a natural number of 2 or more.

By such a configuration, the light in the wavelength band matching the reflection band of each dichroic mirror 220B among the scattered light L2 is reflected and collected by the reflected light collection camera 212B matched thereto, and the light in the remaining band may pass and be collected by the passing light collection camera 211B.

For example, referring to FIG. 8, the scattered light L2 scattered from the sample travels from the bottom to the top. In this case, the wavelength of the scattered light L2 may identically match the wavelength of the illumination light L1 emitted from the lighting unit 100 described above. When the scattered light L2 is formed of a first wavelength and the first dichroic mirror 220B-1 is configured to reflect light of the first wavelength, the scattered light L2 of the first wavelength passes through the second dichroic mirror 220B-2, and is reflected from the first dichroic mirror 220B-1 and collected by the first reflected light collection camera 212B-1. Through this configuration, the present invention may selectively collect the scattered light L2 matching the wavelength of the illumination light L1.

FIG. 9 is a schematic diagram of a light receiving unit according to a third embodiment of the present invention. This example utilizes turret manner driving of the plurality of dichroic mirrors.

As illustrated, the light receiving unit 200C of this example includes a camera 210C, a mirror plate 220C, and a control unit 230C. Here, the light receiving unit 200A may correspond to the light receiving unit 200 of FIG. 2 described above.

More specifically, the light receiving unit 200C of this example may be configured to include n dichroic mirrors 221C that reflect light of different wavelengths respectively a mirror plate 220C that rotates in a turret manner, a control unit 230C that controls the rotation of the mirror plate 220C, a reflected light collection camera 212C that collects the light reflected from one of the dichroic mirrors 221C of the mirror plate 220C, and a passing light collection camera 211C that collects light passing through one of the dichroic mirrors 221C of the mirror plate 220C. Here, n is a natural number of 2 or more.

In the light receiving unit 200C having this structure, the control unit 230C may rotate the mirror plate 220C to match the wavelength of the illumination light L1 irradiated from the lighting unit 100. Referring to FIG. 9, the scattered light L2 scattered from the sample proceeds from the bottom to the top. In this case, the wavelength of the scattered light L2 may identically match the wavelength of the illumination light L1 irradiated from the lighting unit 100 described above. For example, when the scattered light L2 is formed of the first wavelength and a first dichroic mirror 221-1C of the mirror plate 220C is configured to reflect the light of the first wavelength, the control unit 230C rotates the mirror plate 220C so that the first dichroic mirror 221-1C is positioned on the optical path of the scattered light L2, so the scattered light L2 of the first wavelength may be reflected from the first dichroic mirror 221-1C and collected by the reflected light collection camera 212C. Through this configuration, the present invention may selectively collect the scattered light L2 matching the wavelength of the illumination light L1.

In this way, the present invention may selectively receive the scattered light to match the wavelength of the illumination light irradiated from the lighting unit, so the overall detection ability may be improved.

Next, the present invention may adjust the length of the line light L1 irradiated from the lighting unit 100. Referring back to FIG. 3, as described above, the lighting unit 100 of the present invention includes a lens optical system 120 that is composed of a plurality of lenses 121 for forming the light L0 emitted from the light source 111 in a line shape, so the illumination light L1 emitted from the lighting unit 100 may be composed of the line light. In this case, the present invention may adjust the length of the corresponding line light L1.

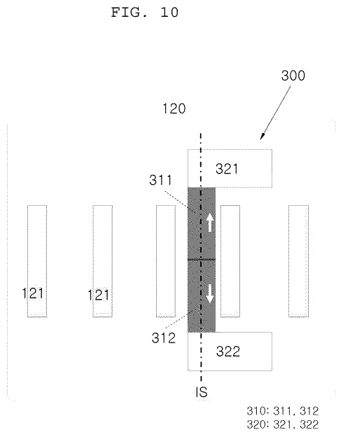

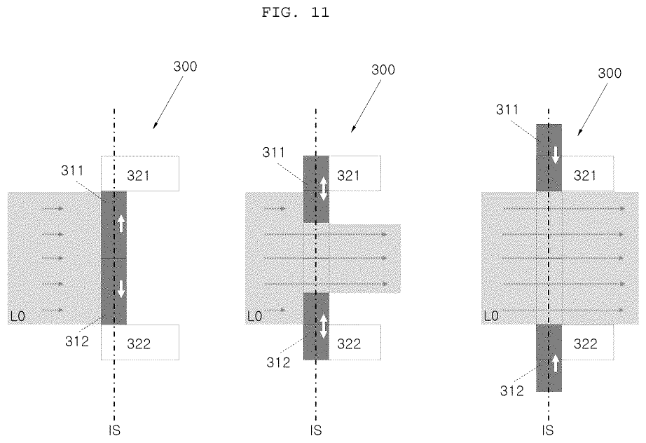

FIG. 10 is a diagram schematically illustrating a light length adjustment unit according to an example of the present invention. The light length adjustment unit 300 may adjust the length of the line light L1 irradiated from the lighting unit 100. For example, the light length adjustment unit 300 may be positioned inside the lens optical system 120 described above, so the line light L1 whose length is finally adjusted may be irradiated from the lighting unit 100.

The light length adjustment unit 300 may be configured to include a shutter 310 that is installed at a position in the optical path between the light source 111 and the sample and can be opened and closed, and a control unit 320 that controls the opening and closing of the shutter 310. FIG. 11 is a diagram schematically illustrating the operation of the light length adjustment unit. The leftmost diagram illustrates a case where all the shutters 310 are closed, the central diagram illustrates a case where some of the shutters 310 are opened or closed, and the rightmost drawing illustrates a case where all the shutters 310 are opened. As illustrated, the degree of opening and closing of the shutter 310 may be adjusted by the control unit 320, and light passes only through the opened portion of the shutter 310 and is shielded at the closed portion, so the length of light passing through the shutter 310 may be adjusted.

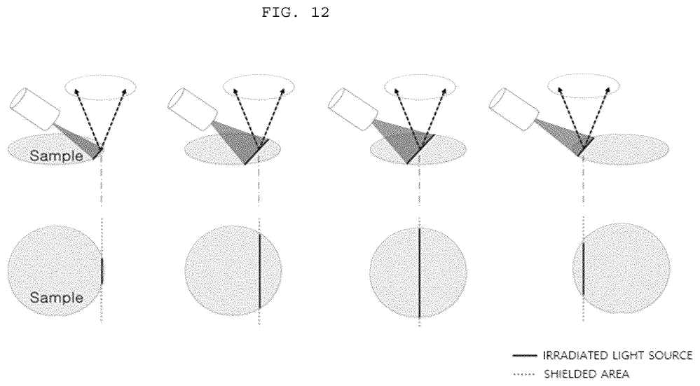

FIG. 12 is a diagram illustrating the line light irradiated for each position of the sample. As illustrated, the length of the line light is adjusted to match the sample to which the line light is irradiated, so only the sample is illuminated with the line light, and the areas other than the sample are not illuminated. In this way, according to the present invention, the irradiation area is adjusted so that the illumination light may be irradiated only to the sample, so that the diffuse reflection in areas other than the sample may be minimized, thereby reducing noise components and improving image quality.

Referring back to FIGS. 10 and 11, the shutter 310 includes a first shutter unit 311 that is opened and closed in a first direction, and a second shutter unit 312 that is open and closed in a second direction, the control unit 320 includes a first control unit 321 that controls the opening and closing of the first shutter unit 311, and a second control unit 322 that controls the opening and closing of the second shutter unit 312, and each of the first shutter unit 311 and the second shutter unit 312 may be controlled (driven) simultaneously or individually by the first control unit 321 and the second control unit 322. With this configuration, it is possible to adjust the length of the line light and at the same time adjust the position at which the line light is irradiated on the sample, so the illumination light may be irradiated only to the sample with greater precision.

Furthermore, referring back to FIG. 10, the shutter 310 may be installed on an imaging surface IS. More specifically, according to the present invention, through the appropriate design of the plurality of lenses 121 of the lens optical system 120, the imaging surface IS may be formed at a position inside the lens optical system 120 where the light emitted from the light source 111 is imaged in the line shape. That is, the light emitted from the light source 111 may travel in the form of parallel light on the imaging surface IS. By positioning the shutter 310 on this imaging surface IS, it is possible to easily and intuitively adjust the length of the line light L1 by adjusting the degree of opening and closing of the shutter 310, and also stably relay the line light whose length is adjusted to the sample as it passes through the imaging surface IS.

As described above, the present invention provides means to solve the problems of the dark-field lighting system, and specifically, by varying the wavelength of the illumination light, it is possible to minimize the penetration loss and penetration depth of the illumination light onto the sample, by selectively receiving the scattered light, it is possible to improve the detection ability, and by adjusting the length of the line light, it is possible to reduce the diffuse reflection generated in the areas other than the sample by irradiating light only to the sample.

According to the present invention, by varying the wavelength of the illumination light, it is possible to minimize the scattering signals corresponding to the internal defects by minimizing the transmission loss and penetration depth of the illumination light on the sample, by selectively receiving the wavelength of the scattered light, it is possible to improve the detection ability, and by adjusting the irradiation area of the illumination light, it is possible to reduce the influence of diffuse reflection signals generated in areas other than the sample by irradiating light only to the sample.

Although exemplary embodiments of the present invention has been described with reference to the accompanying drawings, those skilled in the art will appreciate that various modifications and alterations may be made without departing from the spirit or essential feature of the present invention. Therefore, it should be understood that the above-mentioned embodiments are exemplary in all aspects but are not limited thereto.

What is claimed is:

1. A dark-field inspection device, comprising:
a lighting unit that illuminates a sample with illumination light; and
a light receiving unit that collects scattered light scattered from the sample when the illumination light is irradiated to the sample,
wherein the lighting unit is configured to vary a wavelength of the illumination light irradiated from the lighting unit.

2. The dark-field inspection device of claim 1, wherein the lighting unit includes a light source, a variable bandpass filter that passes light of different wavelength bands for each position, and a control unit,
the control unit adjusts a position of the variable bandpass filter, and
among the light emitted from the light source, only light in a specific wavelength band matching the position of the variable bandpass filter passes, so the wavelength of the illumination light is configured to be variable.

3. The dark-field inspection device of claim 2, wherein the light source is a multi-wavelength light source or a white light source.

4. The dark-field inspection device of claim 1, wherein the lighting unit includes a plurality of light sources that emit light of different wavelengths respectively a mixing optical system that passes only light emitted from one of the plurality of light sources or mixes light emitted from two or more light sources and passes the mixed light, and a control unit,
the control unit individually controls a power supply of each of the plurality of light sources, and
the wavelength of the illumination light is configured to be variable through interaction between the plurality of light sources and the mixing optical system.

5. The dark-field inspection device of claim 4, wherein the mixing optical system includes at least one dichroic mirror.

6. The dark-field inspection device of claim 1, wherein the light receiving unit is configured to selectively receive light in a specific wavelength band among the scattered light.

7. The dark-field inspection device of claim 6, wherein the light receiving unit includes a variable bandpass filter that passes light of different wavelength bands for each position, a control unit, and a camera that collects the light passing through the variable bandpass filter, and
the control unit adjusts a position of the variable bandpass filter, so, among the scattered light, only light in a specific wavelength band matching the position of the variable bandpass filter is configured to pass through and be collected by the camera.

8. The dark-field inspection device of claim 7, wherein the control unit adjusts the position of the variable bandpass filter to match the wavelength of the illumination light irradiated from the lighting unit.

9. The dark-field inspection device of claim 6, wherein the light receiving unit includes n dichroic mirrors that reflect light of different wavelengths respectively and n reflected light collection cameras that individually match each dichroic mirror to collect the light reflected from each of the n dichroic mirrors, and a passing light collection camera that collects light passing through all the n dichroic mirrors, so, among the scattered light, light in a wavelength band matching the reflection band of each of the dichroic mirrors is reflected and collected by the reflected light collection camera that matches each dichroic mirror (where n is a natural number of 2 or more).

10. The dark-field inspection device of claim 6, wherein the light receiving unit includes a mirror plate that includes n dichroic mirrors that reflect light of different wavelengths respectively and is driven to rotate in a turret manner, a control unit, a reflected light collection camera that collects light reflected from the mirror plate, and a passing light collection camera that collects light passing through the mirror plate, and
the control unit rotates the mirror plate, so, among the scattered lights, light in a wavelength band matching the reflection band of any one dichroic mirror of the mirror plate is reflected and collected by the reflected light collection camera, and light in the remaining band is configured to pass through and be collected by the passing light collection camera (where n is a natural number of 2 or more).

11. The dark-field inspection device of claim 1, wherein the lighting unit includes a light source and a lens optical system that is composed of a plurality of lenses for forming the light emitted from the light source in a line shape, so the lighting unit irradiates line light of a certain length.

12. The dark-field inspection device of claim 11, further comprising:
a light length adjustment unit that adjusts a length of the line light irradiated from the lighting unit.

13. The dark-field inspection device of claim 12, wherein the light length adjustment unit includes a shutter that is installed at a position in an optical path between the light source and the sample and configured to be open and closed, and a control unit that controls the opening and closing of the shutter, and
the length of the line light is adjusted according to a degree of opening and closing of the shutter.

14. The dark-field inspection device of claim 13, wherein the shutter includes a first shutter unit that is opened and closed in a first direction, and a second shutter unit that is opened and closed in a second direction,
the control unit includes a first control unit that controls the opening and closing of the first shutter unit, and a second control unit that controls the opening and closing of the second shutter unit, and
the first shutter unit and the second shutter unit are controlled simultaneously or individually by the first control unit and the second control unit.

15. The dark-field inspection device of claim 13, wherein an imaging surface on which the light emitted from the light source is imaged in a line shape is formed at a position inside the lens optical system, and
the shutter is installed on the imaging surface.
